(19) United States
(12) Patent Application Publication
(10) Pub. No.: US 2002/0075141 A1
(43) Pub. Date: Jun. 20, 2002

(54) Safety apparatus for a vehicle

(76) Inventors: Heinrich Lang, Ergersheim (DE); Michael Witzke, Ansbach (DE)

Correspondence Address: Bernard S. Klosowski, Jr., Dority & Manning, Attorneys at Law, P.A., P.O. Box 1449, Greenville, SC, 29602, US

(21) Appl. No.: 09/886,952

(22) Filed: Jun. 21, 2001

(30) Foreign Application Priority Data
Dec. 15, 2000 (DE) 10062655.6

(51) Int. Cl. B60Q 1/00

(52) U.S. Cl. 340/438; 340/901; 340/425.5

(57) ABSTRACT

A safety apparatus for vehicles is disclosed. The safety apparatus has a mirror assembly including a sensor for remotely sensing a road surface temperature and may have a display to inform a driver of driving conditions based in part on the road surface temperature.

### FIELD OF THE INVENTION

The invention concerns a safety apparatus for vehicles, especially for commercial vehicles. More particularly, the invention relates to a sensor that can be installed in some area of a rearview mirror housing for measuring temperatures, for example, of a road surface.

### BACKGROUND OF THE INVENTION

Sensors are known which can determine the temperature of a road surface without touching. Such sensors are utilized, for instance, in the case of vehicles used for snow clearance and anti-skid spreaders in winter service. From the road surface temperature data and, if possible, the ambient and/or air temperature, the probabilities of possible road surface icing can be extrapolated. Consequently, the spreading of salt, other freezing point depressors, stone particulate or the like can be better calculated to meet actual needs.

### BRIEF SUMMARY OF THE INVENTION

The invention proposes to place in some area of a rearview mirror housing at least one sensor of the type which, without touching, measures the road surface temperature.

Preferentially, the road surface temperature sensor, which operates without touching, functions on the basis of infrared radiation. The sensor receives the emitted temperature radiation, i.e. infrared, from the road surface. Such infrared temperature sensors, which operate without contact, nevertheless are positioned to measure a very wide range of temperatures with a very high level of precision.

The measured temperature from the sensor is made known to the driver either by a visual image or alpha-numeric display. In this matter, the presentation can be carried out in accord with such installation methods as appropriate for mirror housings. Another possibility exists in placing the presentation somewhere on the instrument panel of the vehicle.

If the presentation is carried out in an area of the mirror housing, it is possible to integrate the presentation directly in the surface of the pane of the rearview mirror. In accord with another possible manner of displaying the data, the presentation can be placed in the edge area that peripherally encompasses the mirror. A third possibility is to place the display in an area of the mirror housing within the field of view of the driver. In any of 7, these cases, the road surface temperature detected by the non-touching sensor can be presented clearly to the driver.

The display itself can be accomplished in different ways. For instance, the display can take the form of a directly readable decimal value (with corresponding positive or negative prefixes). Alternatively, the display may be an analog value, for instance, on a circular or columnar scale along which a pointer moves, or the temperature can be shown by light emitting elements such as LED's.

In the case of an LED display, if needed, the necessary data can be reduced to three statements, e.g.:

“No Danger” (i.e., black or invisible ice not present), which would be a green LED;

“Danger under certain conditions is possible” resulting in a yellow signal; and

“Danger” (appropriately, a red display).

In addition, the display can be in the form of at least two colors, or generated by a plurality of light emitting elements providing bar graphs or the like.

Upon the failure to attain, or when exceeding a threshold temperature value, an additional alarm, in particular an acoustic alarm, can be provided. The threshold value(s) at which this auxiliary alarm is triggered preferably is adjustable.

Advantageously, the sensor measures, in addition to the temperature of the road surface, the surrounding conditions or the air temperature. The predictability of possible black-ice danger can be made more precise by this information.

The measured temperature values as provided by the sensor can also be recorded or saved in memory. In this way, it becomes possible to create a temperature profile of a certain section of road from which conclusions may be drawn in regard to possible locations of danger. The temperature values can also be sent by radio transmission to a central storage or evaluation unit, for instance, to the winter service center of a roads department.

The aligning of the sensor in regard to the road surface is advantageously adjustable. Adjustment of the sensor prevents parts of the vehicle body, or a tire during a turning maneuver, from entering the detection zone of the sensor, which would otherwise cause false indications.

A further advantageous embodiment of the safety apparatus in accordance with the invention includes:

at least one vehicle-mounted sensor for the non-touching determination of road surface temperature,

a computer for the determination of the immediate location of the vehicle, possessing in particular a GPS apparatus,

a memory apparatus for storing conditions of specific road sections, which, when subjected to certain temperatures, become critical for vehicle traffic, and

a display and/or warning system for the emission of an optical and/or acoustical signal to the driver when the temperature of the road surface measured by the sensor, and/or the surrounding/air temperature before reaching the critical road sections, shows a value which fails to attain or exceeds a specified threshold.

In accord with a further development of equipping the vehicle, the computer can automatically and coercively compel a slowing down or braking if, upon the approach of the vehicle to a critical road section, the sensor detects that temperatures of the road surface, surrounding environment and/or air temperatures fail to attain or exceed the specified threshold values. This coercive slowing of the vehicle by the computer can always be effected if the driver on his own does not signal, slow down or brake after a certain period following an alarm.

### BRIEF DESCRIPTION OF THE DRAWINGS

Further details, aspects and advantages of the present invention are evident from the following description with the aid of the drawings. There is shown in:

FIG. 1 a simplified front view of a vehicle equipped with the safety apparatus in accord with an embodiment of the invention;

FIG. 2 a schematic view of a mirror pane of an outside, rearview mirror exhibiting a variety of possibilities for the presentation or display of the temperature; and

FIG. 3 a schematic block diagram of the invented apparatus in the form of a combination of a non-touching, measuring sensor and a computer for the determination of the location of the vehicle.

### DETAILED DESCRIPTION OF THE DRAWINGS

Detailed reference will now be made to the drawings in which examples embodying the present invention are shown. The drawings and detailed description provide a full and detailed written description of the invention, and of the manner and process of making and using it, so as to enable one skilled in the pertinent art to make and use it, as well as the best mode of carrying out the invention. However, the examples set forth in the drawings and detailed description are provided by way of explanation of the invention and are not meant as limitations of the invention. The present invention thus includes any modifications and variations of the following examples as come within the scope of the appended claims and their equivalents.

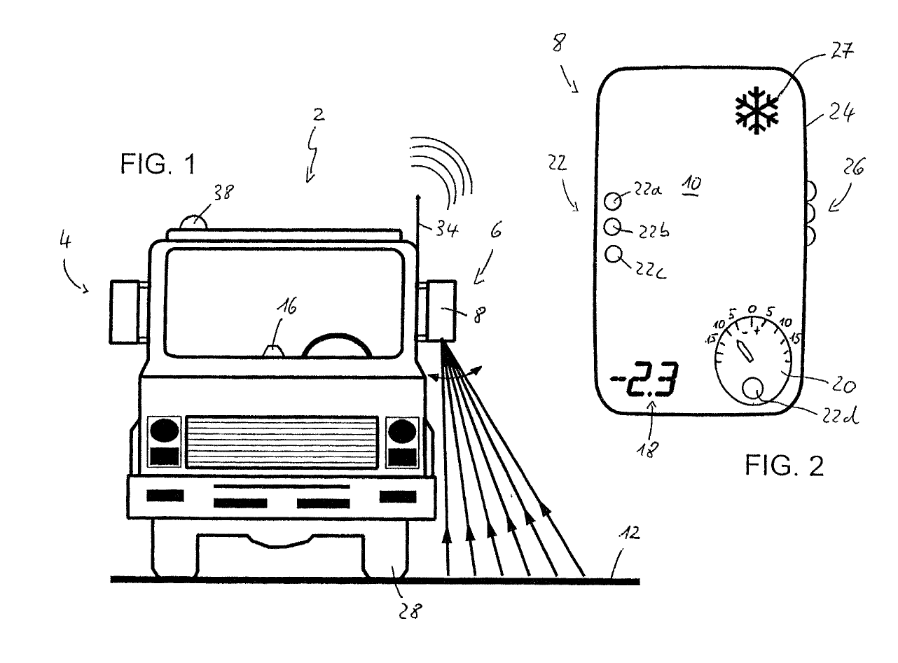

FIG. 1 shows a simplified front view of a vehicle 2, which in the depicted embodiment could be a commercial vehicle. The vehicle 2 exhibits, in a known manner, at least one outside rearview mirror, although two such mirrors 4 and 6 would be preferred. The rearview mirror 4 in the illustrated case is on the passenger side and the rearview mirror 6 is found on the driver's side. In the following, only the driver's side, outside rearview mirror 6 will be the subject of detailed observation. However, let it be understood, that the comments regarding rearview mirror 6 apply in equal measure to rearview mirror 4.

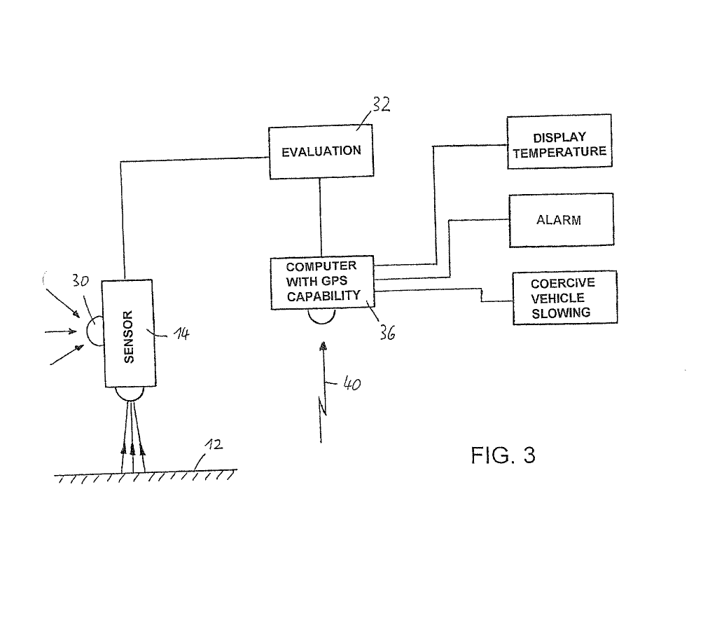

The rearview mirror 6 possesses a mirror housing 8, which in the conventional manner is secured to the body of the vehicle 2. The mirror housing 8 serves for the reception of at least one mirror pane 10 (FIG. 2). Within the confines of the mirror housing 8 is installed at least one sensor 14 for determining the temperature of the road surface 12 without touching (FIG. 3). Repeated measurements 15 of the road surface 12 by the sensor 14 may occur up to ten times per second. This level of monitoring ensures a high reading reliability in regard to temperature of the road surface 12.

Sensors are available that operate with a precision of ±1° C. and have a range suitable for the road surface temperatures of −40° C. to +95° C. The sensor 14 is of conventional design and illustratively operates in the infrared portion of the electromagnetic spectrum. Accordingly, the road surface temperature is captured by the illustrated infrared sensor 14 because of the so-called grey body radiation emitted from the road surface 12.

The temperature measured by the sensor 14 can be presented visually to the driver of the vehicle 2. To accomplish this, the presentation can take place either in an area of the mirror housing 8 or in a location on the instrument panel (not shown) of the vehicle 2 by installation of a display 16 in that location.

The presentation of the temperature can be made in the area of the mirror housing 8 in accord with FIG. 2. This can be done directly in the surface of the corresponding mirror pane 10. This presentation can be carried out in a multitude of ways. For instance, the possibilities for display could include showing the temperature decimally in digital figures as is shown by the display 18 in FIG. 2, which for example shows the value “-2.3”.

With an equal reading facility, the display can be presented by at least one, but preferably a plurality of light emitting elements 22. For instance, by the use of three LEDs, the upper LED 22a can emit a green light, the light 22b immediately thereunder can be yellow, and the bottom light 22c can show red. If the green LED 22a is lit, this indicates that the road surface temperature is clearly above a specified threshold value. If the yellow LED 22b illuminates, then the road surface temperature is at or closely approaching the threshold value. If the red LED 22c lights up, then the road surface temperature is below the threshold value and an acute danger of black ice exists.

Alternatively, the display can be presented on a scale 20 in analog form. A light emitting element, as described, can in the form of a further LED 22d be combined with the analog display or the scale 20, and in that position blink, if a defined critical or threshold value was not attained or was exceeded.

Instead of three light emitting elements or LEDs, it is possible to utilize one bar chart in at least two colors. Like the LEDs, the bar chart indicates the existing road surface temperatures.

It is also possible to place the light emitting elements 22 in a front, bordering edge 24 of the mirror housing 8. The bordering edge 24 must then be constructed wider than indicated in FIG. 2. Further, it is possible to place the LEDs on the side of the mirror housing 8 in such a manner that they lie within the field of vision of the driver. In the case of an outside rearview mirror 6 on the driver's side, the LEDs are located, in the view of FIG. 2, on the right side of the mirror housing 8, i.e., the side nearest the driver. This placement is made clear in FIG. 2 by the locations of the LEDs 26.

A symbol, such as the snow or ice crystal symbol 27 in FIG. 2, can also be employed as a display. This symbol 27, for example, can illuminate itself in the case of black ice danger, or blink, or selectively light through backlight-switching of the three different colors of LEDs to show its message in any one of the three colors. As in the case of the three individual LEDs 22a, 22b, 22c, a green illuminated or blinking symbol 27 indicates that the road surface temperature lies clearly above a critical or threshold value, and a yellow or orange symbol indicates that the road surface temperature is closely approaching the critical or threshold value. Should the symbol illuminate in red, the road surface temperature lies below the specified critical or threshold value and an acute danger of black ice exists.

Further combinations of the individual displays 18, 20, 22, 26 and 27 are possible. For instance, the LEDs 22a, 22b, and 22c, the LEDs 26 and the LEDs behind the symbol 27 can emit continuous light or blink.

In addition to the individual displays as shown in FIG. 2, an acoustic alarm (not shown) can be installed, for instance, in the driving compartment of the vehicle 2. The acoustic alarm can be activated if a specified critical or threshold value of the road surface temperature is exceeded or is not attained.

The alignment of the sensor 14 in regard to the surface of the road 12 is preferably adjustable within a specified range, such as is indicated in FIG. 1 by the double arrow 13, in order to assure that the sensor 14 monitors the road surface and not parts of the body of the vehicle 2.

The alignment further prevents sensor 14 from reacting to the displacement of the front tires 28 when the tires 28 turn generally under an area 29 beneath the rearview mirror 6 thereby protruding beyond the peripheral limits or the outer contour of the body of the vehicle 2.

It is self evident that a plurality of critical or threshold values can be specified for which a failure to attain or surpassing these values can result in visual or acoustic alarm signals. Advantageously, at least one of these critical or threshold values should be adjustable. Furthermore, the sensor 14 advantageously measures not only the temperature of the surface of the road 12, but by addition of a temperature element 30, the surrounding conditions or outside air temperature may be measured and displayed as shown in FIG. 3. An appropriate evaluation device 32 connected to sensor 14 can utilize the additional temperature measurement 31 made by element 30 to provide even more exact information in regard to the possibility or expectancy of the condition (black ice formation, etc.) of the road surface.

It is possible that in one rearview mirror assembly, several sensors such as sensor 14 can be installed and/or both rearview mirrors 4 and 6 can each be equipped with one sensor 14. Accordingly, signals 15 and 31 coming from the sensor, or sensors 14, can be recorded in a memory device (not shown) on board the vehicle 2 or be stored therein. Consideration can be given to electronic memory media, electro-optical recording instruments or magnetic storage media, such as ICs, CD-ROMs, diskettes, magnetic tapes and the like to record the sensor signals 15 and 31. These recorded temperature measurement values 15 and 31 can, for instance, be compiled to achieve a definite temperature profile of a particular stretch of road 12 covered by a vehicle 2.

Alternatively, or in addition to storing the measured temperature values 15 and 31 in an on-board storage, they can be sent by radio over a sender 34 to a distant receiver station (not shown) for storage and evaluation. This remote transmission is especially suited for data collection at a winter service office or a transportation agency.

FIG. 3 shows a further advantageous embodiment of the present invention in a simplified block circuit drawing. In this arrangement, one sensor 14 is combined with a computer 36 via an evaluation unit 32. Alternately, a plurality of sensors 14 can be combined with a computer 36 by separate evaluation units 32 or by a central evaluation unit 32.

The computer 36 has the capability of determining the immediate position of the vehicle, especially when a so-called Global Positioning System (GPS) apparatus (not shown separately) is employed. In a conventional manner, the GPS-equipped computer 36 receives GPS signals 40 over a receiver 38 and from this reception determines the current location of the vehicle 2. The GPS/computer 36 processes the GPS signals 40 and those temperature signals from the evaluation unit 32 engendered by one or more sensors 14.

The computer 36 can contain a memory system for the storage of road sections, which, at particular temperature conditions, critically affect the driving behavior of the vehicle 2. The GPS/computer 36 compares or correlates the received signals or data statements with its archived, prior evaluated signal content. The computer 36, upon the approach of the vehicle 2 to the critical road stretch, now combines present and archival temperature conditions. Having done so, the computer 36 is able to warn the driver when the road surface temperature measured by the sensor(s) 14 is less than or exceeds a defined value and appropriately, that the road section approached is critical, i.e., it may harbor dangerous driving conditions.

In other words, the GPS/computer 36 determines immediate vehicle position from the GPS signals 40 and extrapolates forward over a road stretch of 500 meters, for example. The computer 36, based on the signals concerning the road surface temperature and its memory content concerning critical road stretches, may determine that in the road section being approached by the vehicle 2, black ice danger may be present. If this is the situation, the computer 36 can make a decision or statement that, considering the immediate vehicle position, the possibility of latent black ice danger within the next 500 meters, for example, is high. The computer will correspondingly inform or warn the driver of this black ice danger.

By way of further illustration, the computer 36 “knows” that within 500 meters ahead, a bridge or overpass, or even a permanent overshadowing copse of trees will appear. Further, the computer 36 considers that the vehicle 2 is approaching a location where, under certain temperature conditions, a danger exists for the particular vehicle 2. If at this point the temperature signals, for instance, show a latent black ice danger, then the computer 36 will directly inform the driver that in front of the vehicle 2, a location or a place lies where a black ice buildup must be taken into consideration; i.e., what was once a theoretical ice situation is now a real one.

The computer 36 also controls, in accord with FIG. 3, the various modes of display of the temperature, somewhat in the manner of FIG. 2. Thus, the computer 36 sounds the acoustical alarm and may be programmed to affect or control the driving behavior of the vehicle 2. In accord with FIG. 3, the GPS computer 36, for instance, can intervene in the handling of the driving of the vehicle 2. This is done if, upon the approach of the vehicle to the critical road section, the road surface temperature and/or the ambient temperature as detected by the sensor 14, fails to attain or exceeds the specified critical or threshold values. This intrusion into the driving operation is advantageous in that the computer 36 automatically and coercively slows the vehicle speed or applies braking. The computer 36 carries this out by entering the motor control, for instance, to change the degree of throttle valve opening in order to restrict the travel speed of the vehicle 2. This occurs when nearing, as detected by the computer 36 and described above, a section of road critical for the travel behavior of the vehicle 2 under circumstances of specified temperature conditions.

This coercive slowing of the vehicle 2 by the computer 36 can further occur with time delay in that the automatic slowing will only be undertaken if the driver of the vehicle 2 does not himself reduce speed within a given time-span after a warning is given (for instance, an acoustic warning) or if the driver does not react at all.

What has been described is a safety apparatus for vehicles, in particular for commercial vehicles. However, the present invention can not only be utilized by commercial vehicles but also can be employed by personal vehicles for private use. The vehicles have an outside, rearview mirror, which includes a mirror housing with at least one mirror pane placed therein. In the confines of the mirror housing at least one sensor is placed which measures, without touching, the road surface temperature.

In one embodiment the non-touching, sensor of road surface temperature is combined with a computer, especially with a GPS-apparatus, which determines the immediate vehicle position. Also, the sensor is controllingly connected with a memory storage device for the storage of road sections'characteristics, which under certain temperature conditions are critical to the handling characteristics of the vehicle. Further, in the control circuit is a display or warning apparatus for providing an optical and/or acoustic warning signal directed at the driver. This occurs if the road surface temperature measured by the sensor, and/or the ambient or air temperature before reaching the critical road section, exceeds or fails to attain a specified critical or threshold value.

It will be apparent to those skilled in the art that various modifications and variations can be made in the present invention without departing from the scope and spirit of the invention. For example, specific shapes of various elements and warning mechanisms of the illustrated embodiments may be altered to suit particular applications. It is intended that the present invention include such modifications and variations as come within the scope of the appended claims and their equivalents.

Claimed is:

1. A safety apparatus for vehicles, in particular, commercial vehicles with a rear view mirror (4, 6) fastened on a vehicle body, which encompasses a mirror housing (8) with at least one mirror pane (10) placed therein, therein characterized, in that in the confines of the mirror housing (8) is placed at least one sensor (14), which, without touching, measures the surface temperature of the road.

2. A safety apparatus in accord with claim 1, therein characterized, in that the sensor 14, captures infrared temperature radiation emitted from the road surface.

3. A safety apparatus in accord with claim 1 or 2, therein characterized, in that the temperature measured by the sensor (14) is visually displayed to the driver of the vehicle (2).

4. A safety apparatus in accord with claim 3, therein characterized, in that the presentation is carried out in the area of the mirror housing (8).

5. A safety apparatus in accord with claim 3 or 4, therein characterized, in that the display occurs in the surface of the mirror pane (10).

6. A safety apparatus in accord with claim 3 or 4, therein characterized, in that the display in made in a border 24 which peripherally surrounds the mirror surface of the mirror housing (8).

7. A safety apparatus in accord with claim 3 or 4, therein characterized, in that the display is made in an area of the mirror housing (8) within the field of view of the driver.

8. A safety apparatus in accord with claim 3, therein characterized, in that the presentation is done in the area of the instrument panel.

9. A safety apparatus in accord with at least one of the claims 3 to 8, therein characterized, in that the display is presented as a decimal value (18).

10. A safety apparatus in accord with at least one of the claims 3 to 8, therein characterized, in that the display is presented as an analog value (20).

11. A safety apparatus in accord with at least one of the claims 3 to 8, therein characterized, in that the display is effected by means of at least one light emitting element (22; 22d; 26).

12. A safety apparatus in accord with at least one of the claims 1 to 11, therein characterized, in that upon the failure to attain, or the exceeding of a threshold value of the temperature, an auxiliary alarm, especially an acoustic alarm, is activated.

13. A safety apparatus in accord with claim 12, therein characterized, in that the threshold value(s) is adjustable.

14. A safety apparatus in accord with at least one of the claims 1 to 13, therein characterized, in that the sensor (14), in addition to the road surface temperature, measures the ambient or air temperature.

15. A safety apparatus in accord with at least one of the claims 1 to 14, therein characterized, in that the temperature values are recorded or saved in memory.

16. A safety apparatus in accord with at least one of the claims 1 to 15, therein characterized, in that the measured temperature values can be transmitted by radio.

17. A safety apparatus in accord with at least one of the claims 1 to 16, therein characterized, in that the alignment of of the sensor (14) in regard to the road surface (12) is adjustable.

18. A safety apparatus in accord with one of the foregoing claims, with:
at least one, non-touching, road surface temperature sensor (14) placed on a vehicle;
a computer (36) which determines the immediate position of the vehicle, especially by a GPS apparatus;
a memory system for the storage of road sections, which at certain temperature conditions are critical for the driving behavior of the vehicle (2) and
a display or warning apparatus for the promulgation of an optical and/or an acoustic warning signal directed to the driver, when, the road surface temperature measured by the sensor (14) and/or the ambient or air temperature, upon approaching the critical road section, exceeds or fails to attain a specified value.

19. A safety apparatus in accord with claim 18, therein characterized, in that the computer (36) coercively, automatically slows the vehicle (2), upon the approach of said vehicle (2) to a critical section of a road, wherein the road surface temperature and/or the ambient or air temperature exceeds or fails to attain a specified value.

20. A safety apparatus in accord with claim 19, therein characterized, in that the coercive slowing of the vehicle (2) by the computer (36) is activated, if the driver of the vehicle (2), after a predetermined time-span, does not himself slow after the warning signal has been given.
